(19) United States
(12) Patent Application Publication
(10) Pub. No.: US 2026/0051448 A1
(43) Pub. Date: Feb. 19, 2026

(54) COIL SKELETON ASSEMBLY AND ITS MANUFACTURING METHOD, COIL ASSEMBLY AND CONTACTOR

(71) Applicants: Tyco Electronics (Shanghai) Co., Ltd., Shanghai (CN); Tyco Electronics Technology (SIP) Co., Ltd., Suzhou (CN)

(72) Inventors: Zesheng Jiang, Suzhou (CN); Quarry (Bingfeng) Qu, Suzhou (CN); Kevin (Xujia) Wang, Suzhou (CN); Yisong Wu, Shanghai (CN); Wenpei Qin, Suzhou (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/300,731

(22) Filed: Aug. 15, 2025

(30) Foreign Application Priority Data
Aug. 15, 2024 (CN) 202411124471.3

(51) Int. Cl. H01H 50/44; H01H 49/00; H01H 50/02; H01H 50/54

(52) U.S. Cl. CPC H01H 50/44; H01H 49/00; H01H 50/02; H01H 50/54

(57) ABSTRACT

A coil skeleton assembly includes a coil skeleton around which a coil of a contactor is wound, a magnetic tube fixed in the coil skeleton, and a plurality of signal terminals fixed in the coil skeleton. The coil skeleton is directly molded onto the magnetic tube and the signal terminals through embedded injection molding. The coil skeleton, the magnetic tube, and the signal terminals are formed into an integral piece.

### CROSS-REFERENCE TO RELATED APPLICATION

This application claims the benefit of the filing date under 35 U.S.C. § 119 (a)-(d) of Chinese Patent Application No. 202411124471.3, filed on Aug. 15, 2024.

### FIELD OF THE INVENTION

The present invention relates to a coil skeleton assembly, a coil assembly comprising the coil skeleton assembly, a contactor comprising the coil assembly, and a method for manufacturing the coil skeleton assembly.

### BACKGROUND OF THE INVENTION

A contactor typically includes a coil skeleton, a coil wound around the coil skeleton, multiple signal terminals assembled on the coil skeleton, and a magnetic tube assembled in the lower end of the coil skeleton. The coil skeleton of the contactor is a separate injection molded part, which is for winding and fixing the coil. The signal terminals and the magnetic tube of the contactor need to be assembled separately onto the coil skeleton. This arrangement not only leads to a complex coil skeleton structure, but also makes the assembly process of the contactor more complicated, reducing the manufacturing efficiency and increasing the manufacturing cost of the contactor.

### SUMMARY OF THE INVENTION

A coil skeleton assembly includes a coil skeleton around which a coil of a contactor is wound, a magnetic tube fixed in the coil skeleton, and a plurality of signal terminals fixed in the coil skeleton. The coil skeleton is directly molded onto the magnetic tube and the signal terminals through embedded injection molding. The coil skeleton, the magnetic tube, and the signal terminals are formed into an integral piece.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a coil skeleton assembly according to an exemplary embodiment of the present invention when viewed from the top;

FIG. 2 shows an illustrative perspective view of a coil skeleton assembly according to an exemplary embodiment of the present invention when viewed from the bottom;

FIG. 3 shows an illustrative exploded view of a coil skeleton assembly according to an exemplary embodiment of the present invention;

FIG. 4 shows an illustrative perspective view of multiple signal terminals according to an exemplary embodiment of the present invention;

FIG. 5 shows an illustrative perspective view of a coil assembly according to an exemplary embodiment of the present invention;

FIG. 6 shows an illustrative perspective view of a coil skeleton assembly according to another exemplary embodiment of the present invention when viewed from the top;

FIG. 7 shows an illustrative perspective view of a coil skeleton assembly according to another exemplary embodiment of the present invention when viewed from the bottom;

FIG. 8 shows an illustrative exploded view of a coil skeleton assembly according to another exemplary embodiment of the present invention;

FIG. 9 shows an illustrative perspective view of a terminal module according to an exemplary embodiment of the present invention when viewed from the top;

FIG. 10 shows an illustrative perspective view of a terminal module according to an exemplary embodiment of the present invention when viewed from the bottom;

FIG. 11 shows an illustrative exploded view of a terminal module according to an exemplary embodiment of the present invention; and

FIG. 12 shows an illustrative perspective view of a coil skeleton assembly according to another exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

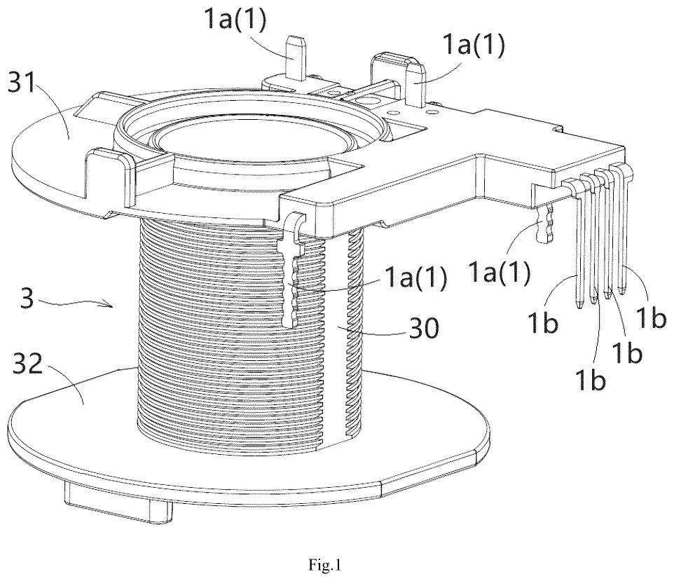

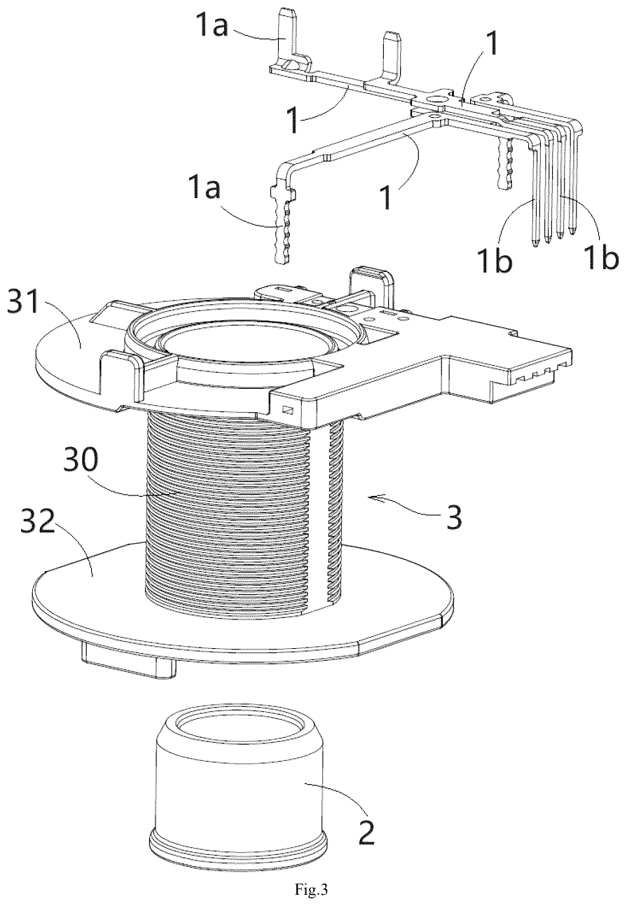

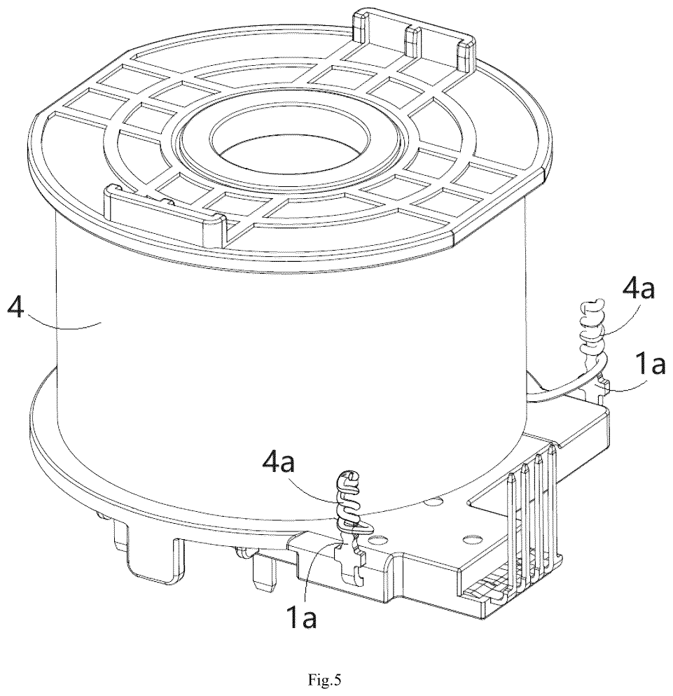

As shown in FIGS. 1 to 5, in an exemplary embodiment of the present invention, a coil skeleton assembly is disclosed. The coil skeleton assembly includes: a coil skeleton 3, a magnetic tube 2, and multiple signal terminals 1. The coil skeleton 3 is used to wind a coil 4 of a contactor on it, as shown in FIG. 5. The magnetic tube 2 is fixed in the coil skeleton 3. Multiple signal terminals 1 are fixed in the coil skeleton 3. The coil skeleton 3 is directly molded onto the magnetic tube 2 and multiple signal terminals 1 through embedded injection molding, making the coil skeleton 3, magnetic tube 2, and multiple signal terminals 1 an integral piece.

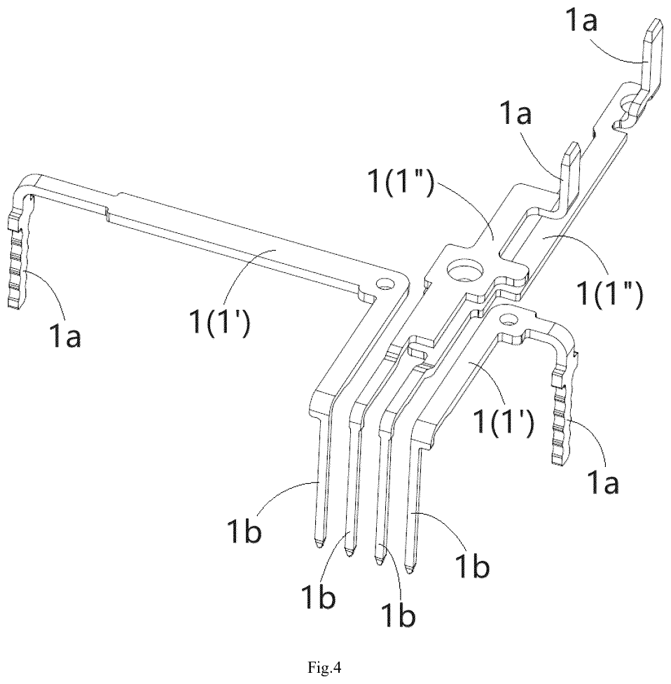

In the illustrated embodiment, the multiple signal terminals 1 include: a pair of coil signal terminals 1′ and/or a pair of auxiliary contact signal terminals 1″, as shown in FIG. 4. A pair of coil signal terminals 1′ are used to electrically connect two ends 4a of the coil 4 of the contactor. A pair of auxiliary contact signal terminals 1″ are used to electrically connect with a pair of auxiliary contacts of the contactor. In the illustrated embodiment, multiple signal terminals 1 include a pair of coil signal terminals 1′ and a pair of auxiliary contact signal terminals 1″. One ends 1a of a pair of coil signal terminals 1′ are exposed from the outside of the coil skeleton 3, and are used to electrically connect with the two ends 4a of the coil 4 of the contactor, respectively, as shown in FIG. 5. One ends 1a of a pair of auxiliary contact signal terminals 1″ are exposed from the outside of the coil skeleton 3, as shown in FIG. 1, for electrical connection with a pair of auxiliary contacts of the contactor, respectively.

As shown in FIGS. 1-4, in the illustrated embodiment, the other ends 1b of a pair of coil signal terminals 1′ and the other ends 1b of a pair of auxiliary contact signal terminals 1″ are arranged in a row for insertion into a signal connector to make electrical contact with multiple mating signal terminals in the signal connector.

In the illustrated embodiment, the coil signal terminal 1′ has a flat main body located between its two ends, and the main body of the coil signal terminal 1′ is perpendicular to the axial direction of the coil skeleton 3 and wrapped in the coil skeleton 3. In the illustrated embodiment, after the two ends 4a of the coil 4 are respectively wound and connected to one end 1a of a pair of coil signal terminals 1′, one end 1a of the coil signal terminal 1′ is bent 90 degrees relative to the main body of the coil signal terminal 1′, and the other end 1b of the coil signal terminal 1′ can be bent 90 degrees relative to the main body of the coil signal terminal 1′ or not bent as needed.

As shown in FIG. 4, in the illustrated embodiment, the auxiliary contact signal terminal 1″ has a flat main body located between its two ends, and the main body of the auxiliary contact signal terminal 1″ is perpendicular to the axial direction of the coil skeleton 3 and wrapped in the coil skeleton 3. One end 1a of auxiliary contact signal terminal 1″ is bent 90 degrees relative to the main body of auxiliary contact signal terminal 1″, and the other end 1b of auxiliary contact signal terminal 1″ can be bent 90 degrees relative to the main body of auxiliary contact signal terminal 1″ or not bent as needed.

As shown in FIGS. 1-3, in the illustrated embodiment, the coil skeleton 3 includes a cylindrical body 30, an upper flange 31, and a lower flange 32. The cylindrical body 30 has upper and lower ends opposite in its axial direction. The upper flange 31 is formed on the upper end of the cylindrical body 30. The lower flange 32 is formed on the lower end of the cylindrical body 30. The cylindrical body 30 is used for winding the coil 4, and the upper flange 31 and lower flange 32 are used to respectively abut against the upper and lower ends of the coil 4.

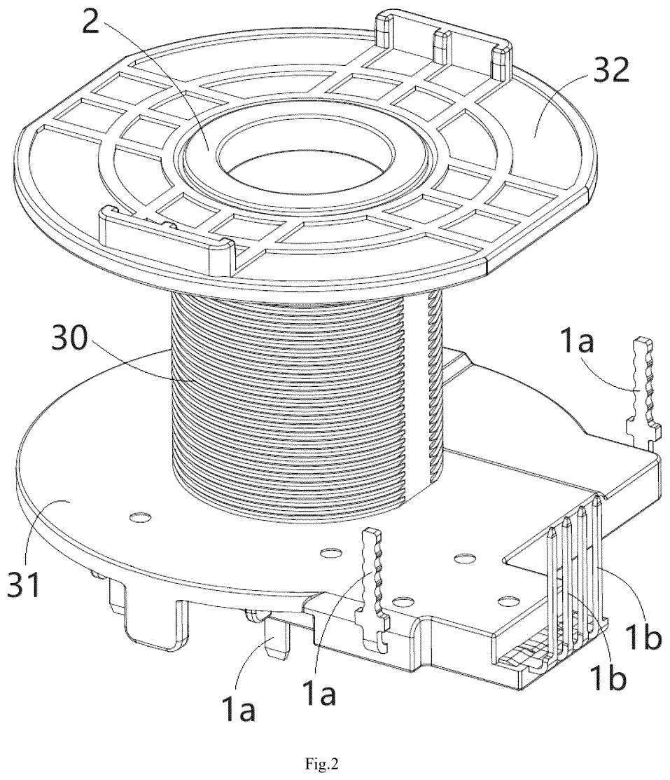

As shown in FIGS. 1 and 2, in the illustrated embodiment, multiple signal terminals 1 are fixed in the upper flange 31 of the coil skeleton 3, and the magnetic tube 2 is fixed in the lower end of the cylindrical body 30 of the coil skeleton 3.

In another exemplary embodiment of the present invention, a coil assembly is also disclosed. The coil assembly includes the aforementioned coil skeleton assembly and the coil 4 which is wound around the coil skeleton 3. Multiple signal terminals 1 include a pair of coil signal terminals 1′, and the two ends 4a of coil 4 are respectively electrically connected to one ends 1a of the pair of coil signal terminals 1′.

In another exemplary embodiment of the present invention, a contactor is also disclosed. The contactor includes a housing and a pair of auxiliary contacts and the above coil assembly arranged in the housing. The multiple signal terminals 1 of the coil assembly include a pair of auxiliary contact signal terminals 1″, the pair of auxiliary contacts are respectively electrically connected to one ends 1a of the pair of auxiliary contact signal terminals 1″.

In another exemplary embodiment of the present invention, a method for manufacturing a coil skeleton is also disclosed. The manufacturing method of the coil skeleton includes the following steps:
S11: Providing multiple signal terminals 1 and a magnetic tube 2; and
S12: By embedding injection molding technology, the coil skeleton 3 is directly formed on multiple signal terminals 1 and the magnetic tube 2, making the coil skeleton 3, multiple signal terminals 1, and the magnetic tube 2 an integral piece, as shown in FIGS. 1 and 2.

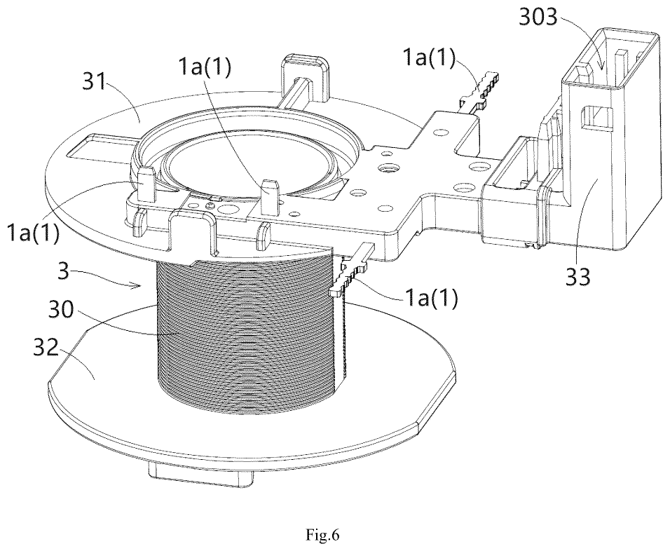

As shown in FIGS. 6 to 12, in an exemplary embodiment of the present invention, a coil skeleton assembly is disclosed. The coil skeleton assembly includes: a coil skeleton 3, a magnetic tube 2, and a terminal module 10. The coil skeleton 3 is used to wind a coil 4 of a contactor on it (see FIG. 5). The magnetic tube 2 is fixed in the coil skeleton 3. The terminal module 10 includes multiple signal terminals 1 and a retaining body 11. The retaining body 11 holds multiple signal terminals 1 together. The coil skeleton 3 is directly molded onto the magnetic tube 2 and the terminal module 10 through embedded injection molding, making the coil skeleton 3, magnetic tube 2, and terminal module 10 an integral piece.

In the illustrated embodiment, the retaining body 11 is directly molded onto multiple signal terminals 1 through insert injection molding, making the retaining body 11 and multiple signal terminals 1 an integral piece. However, the present invention is not limited to the illustrated embodiment. For example, multiple terminal sockets may be formed in the retaining body 11, and multiple signal terminals 1 are respectively inserted into the multiple terminal sockets of the retaining body 11.

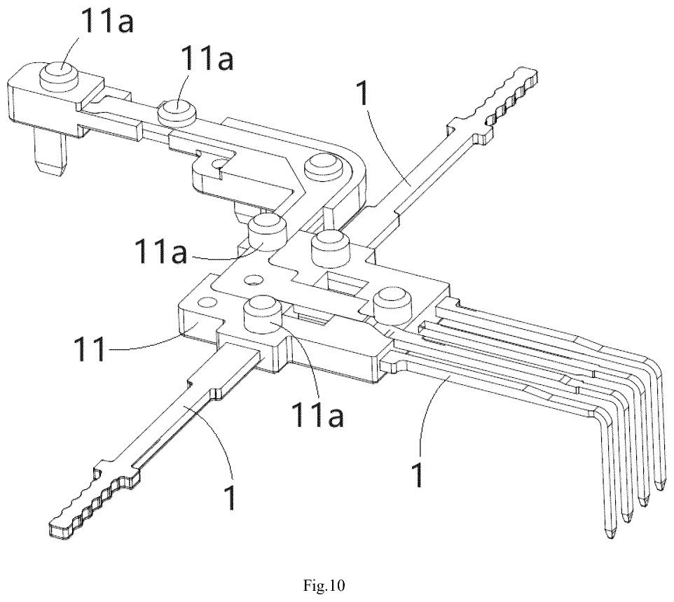

As shown in FIGS. 10, in the illustrated embodiment, multiple positioning posts 11a are formed on the retaining body 11, and the multiple positioning posts 11a are distributed at intervals on the retaining body 11 to achieve positioning between the retaining body 11 and the coil skeleton 3.

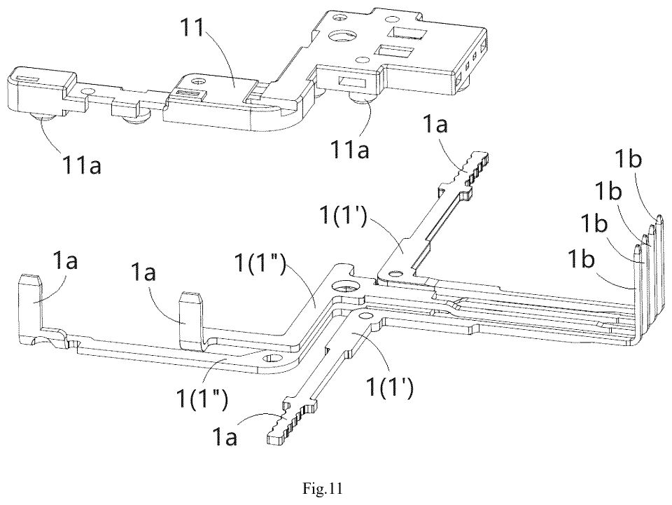

As shown in FIG. 11, in the illustrated embodiment, multiple signal terminals 1 include: a pair of coil signal terminals 1′ and/or a pair of auxiliary contact signal terminals 1″. A pair of coil signal terminals 1′ are used to electrically connect two ends 4a of the coil 4 of the contactor, respectively. A pair of auxiliary contact signal terminals 1″ are used to electrically connect with a pair of auxiliary contacts of the contactor, respectively.

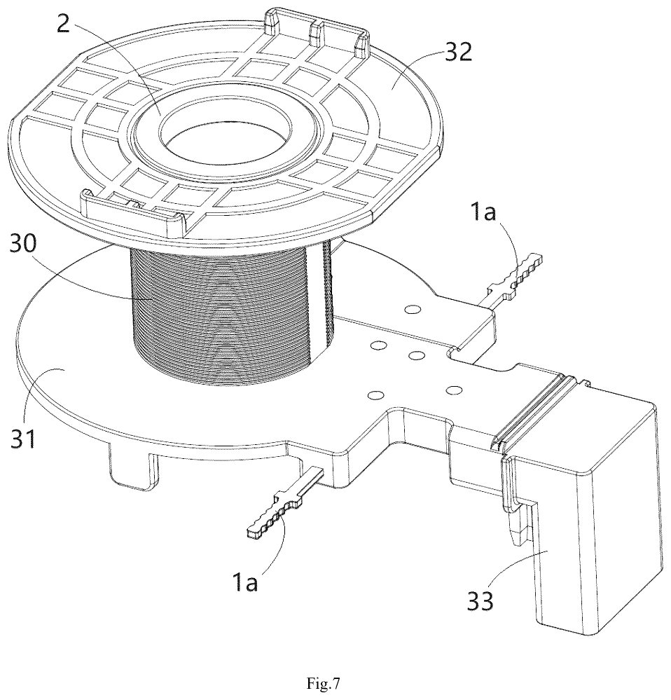

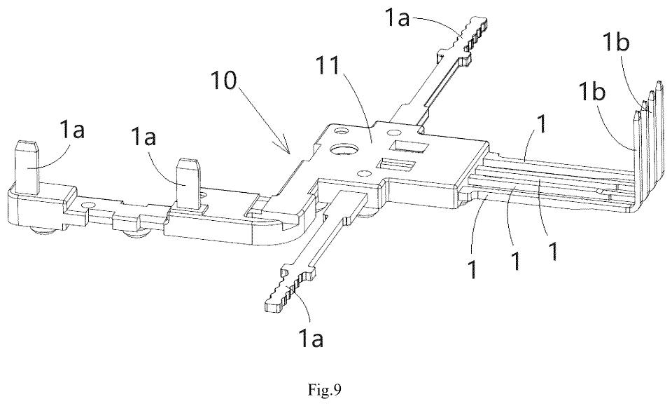

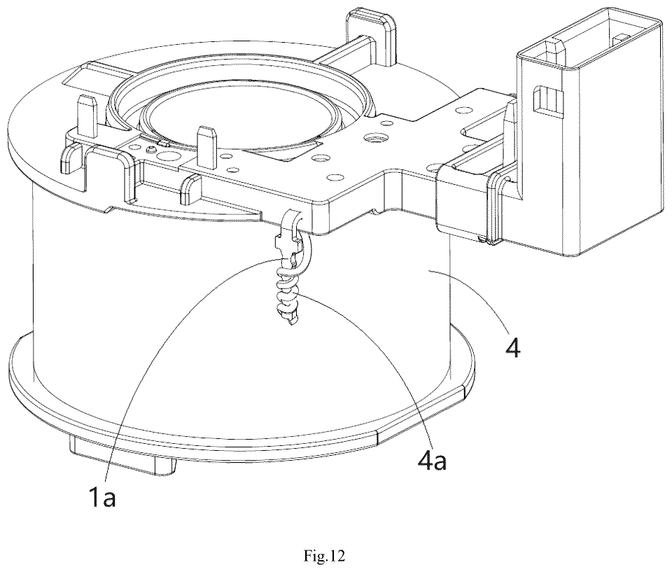

As shown in FIG. 11, in the illustrated embodiment, multiple signal terminals 1 include a pair of coil signal terminals 1′ and a pair of auxiliary contact signal terminals 1″. One ends 1a of a pair of coil signal terminals 1′ are exposed from the outside of the coil skeleton 3, and are used to electrically connect with the two ends 4a of the coil 4 of the contactor, respectively, as shown in FIG. 12. One ends 1a of a pair of auxiliary contact signal terminals 1″ are exposed from the outside of the coil skeleton 3 for electrical connection with a pair of auxiliary contacts of the contactor, respectively, as shown in FIG. 7. In the illustrated embodiment, as shown in FIGS. 9-11, the other ends 1b of a pair of coil signal terminals 1′ and the other ends 1b of a pair of auxiliary contact signal terminals 1″ are arranged in a row for insertion into a signal connector to make electrical contact with multiple mating signal terminals in the signal connector.

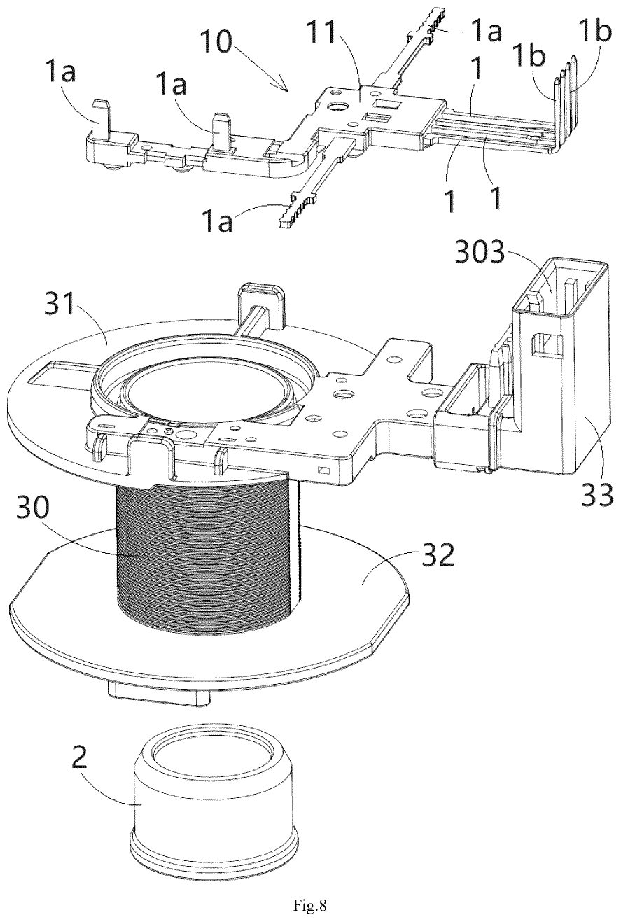

As shown in FIGS. 7 and 8, in the illustrated embodiment, the coil skeleton 3 has a mating portion 33, in which a slot 303 for inserting a signal connector is formed. The other ends 1b of a pair of coil signal terminals 1′ and the other ends 1b of a pair of auxiliary contact signal terminals 1″ extend into the slot 303 of the mating portion 33.

As shown in FIG. 11, in the illustrated embodiment, the coil signal terminal 1′ has a flat main body located between its two ends, and the main body of the coil signal terminal 1′ is perpendicular to the axial direction of the coil skeleton 3 and wrapped in the coil skeleton 3. In the illustrated embodiment, after the two ends 4a of the coil 4 are respectively wound and connected to one ends 1a of a pair of coil signal terminals 1′, one end 1a of the coil signal terminal 1′ is bent 90 degrees relative to the main body of the coil signal terminal 1′, and the other end 1b of the coil signal terminal 1′ can be bent 90 degrees relative to the main body of the coil signal terminal 1′ or not bent as needed.

As shown in FIG. 11, in the illustrated embodiment, the auxiliary contact signal terminal 1″ has a flat main body located between its two ends, and the main body of the auxiliary contact signal terminal 1″ is perpendicular to the axial direction of the coil skeleton 3 and wrapped in the coil skeleton 3. One end 1a of auxiliary contact signal terminal 1″ is bent 90 degrees relative to the main body of auxiliary contact signal terminal 1″, and the other end 1b of auxiliary contact signal terminal 1″ can be bent 90 degrees relative to the main body of auxiliary contact signal terminal 1″ or not bent as needed.

As shown in FIGS. 7 and 8, in the illustrated embodiment, the coil skeleton 3 includes a cylindrical body 30, an upper flange 31 and a lower flange 32. The cylindrical body 30 has upper and lower ends opposite in its axial direction. The upper flange 31 is formed on the upper end of the cylindrical body 30. The lower flange 32 is formed on the lower end of the cylindrical body 30. The cylindrical body 30 is used for winding the coil 4, and the upper flange 31 and lower flange 32 are used to respectively abut against the upper and lower ends of the coil 4.

As shown in FIGS. 7 and 9, in the illustrated embodiment, the terminal module 10 is fixed in the upper flange 31 of the coil skeleton 3, and the magnetic tube 2 is fixed in the lower end of the cylindrical body 30 of the coil skeleton 3.

In another exemplary embodiment of the present invention, a coil assembly is also disclosed. The coil assembly includes the aforementioned coil skeleton assembly and a coil 4 which is wound around the coil skeleton 3. Multiple signal terminals 1 include a pair of coil signal terminals 1′, and the two ends 4a of coil 4 are respectively electrically connected to one ends 1a of the pair of coil signal terminals 1′.

In another exemplary embodiment of the present invention, a contactor is also disclosed. The contactor includes a housing, a pair of auxiliary contacts and the above coil assembly arranged in the housing. The multiple signal terminals 1 of the coil assembly include a pair of auxiliary contact signal terminals 1″, the pair of auxiliary contacts are respectively electrically connected to one ends 1a of the pair of auxiliary contact signal terminals 1″.

In another exemplary embodiment of the present invention, a method for manufacturing a coil skeleton is also disclosed. The manufacturing method of the coil skeleton includes the following steps:
S21: Providing a terminal module 10, which includes multiple signal terminals 1 and a retaining body 11 that holds the multiple signal terminals 1 together; and
S22: By embedding injection molding technology, the coil skeleton 3 is directly formed on the terminal module 10 and the magnetic tube 2, making the coil skeleton 3, terminal module 10, and magnetic tube 2 an integral piece.

In another exemplary embodiment of the present invention, a method for manufacturing a coil skeleton is also disclosed. The manufacturing method of the coil skeleton includes the following steps:
S31: Providing multiple signal terminals 1;
S32: By embedding injection molding technology, the retaining body 11 is directly formed on multiple signal terminals 1 to obtain a terminal module 10 including multiple signal terminals 1 and the retaining body 11; and
S33: By embedding injection molding technology, the coil skeleton 3 is directly formed on the terminal module 10 and the magnetic tube 2, making the coil skeleton 3, terminal module 10, and magnetic tube 2 an integral piece.

In the aforementioned exemplary embodiments according to the present invention, the coil skeleton is directly injection molded onto the signal terminals and the magnetic tube, simplifying the assembly process of the contactor, improving manufacturing efficiency, and reducing manufacturing costs.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A coil skeleton assembly, comprising:
a coil skeleton around which a coil of a contactor is wound;
a magnetic tube fixed in the coil skeleton; and
a plurality of signal terminals fixed in the coil skeleton, the coil skeleton is directly molded onto the magnetic tube and the signal terminals through embedded injection molding, the coil skeleton, the magnetic tube, and the signal terminals are formed into an integral piece.

2. The coil skeleton assembly according to claim 1, wherein the signal terminals include:
a pair of coil signal terminals electrically connected with a pair of ends of the coil of the contactor; and/or
a pair of auxiliary contact signal terminals electrically connected with a pair of auxiliary contacts of the contactor.

3. The coil skeleton assembly according to claim 1, wherein the signal terminals include:
a pair of coil signal terminals, a pair of first ends of the pair of coil signal terminals are exposed from an outside of the coil skeleton, and electrically connect with a pair of ends of the coil of the contactor; and
a pair of auxiliary contact signal terminals, a pair of first ends of the pair of auxiliary contact signal terminals are exposed from the outside of the coil skeleton, and electrically connect with a pair of auxiliary contacts of the contactor.

4. The coil skeleton assembly according to claim 3, wherein a pair of second ends of the pair of coil signal terminals and a pair of second ends of the pair of auxiliary contact signal terminals are arranged in a row for insertion into a signal connector to electrically contact a plurality of mating signal terminals in the signal connector.

5. The coil skeleton assembly according to claim 4, wherein the coil skeleton has a mating portion, a slot for inserting the signal connector is formed in the mating portion, the second ends of the pair of coil signal terminals and the second ends of the pair of auxiliary contact signal terminals extend into the slot of the mating portion.

6. The coil skeleton assembly according to claim 4, wherein each of the coil signal terminals has a flat main body located between the first end and the second end, the flat main body of the coil signal terminal is perpendicular to an axial direction of the coil skeleton and wrapped in the coil skeleton, and after the ends of the coil are wound and connected to the first ends of the coil signal terminals, the first ends of the coil signal terminals are bent 90 degrees relative to the flat main bodies of the coil signal terminals, and the second ends of the coil signal terminals are bent 90 degrees or not bent relative to the flat main bodies of the coil signal terminals.

7. The coil skeleton assembly according to claim 4, wherein each of the auxiliary contact signal terminals has a flat main body located between the first end and the second end, the flat main body of the auxiliary contact signal terminal is perpendicular to an axial direction of the coil skeleton and wrapped in the coil skeleton, the first ends of the auxiliary contact signal terminals are bent 90 degrees relative to the main bodies of the auxiliary contact signal terminals, and the second ends of the auxiliary contact signal terminals are bent 90 degrees or not bent relative to the flat main bodies of the auxiliary contact signal terminals.

8. The coil skeleton assembly according to claim 1, wherein the coil skeleton includes:
a cylindrical body having an upper end and a lower end opposite the upper end in an axial direction;
an upper flange formed on the upper end of the cylindrical body; and
a lower flange formed on the lower end of the cylindrical body, the coil is wound around the cylindrical body, the upper flange rests against an upper end of the coil and the lower flange rests against a lower end of the coil.

9. The coil skeleton assembly according to claim 8, wherein the signal terminals are fixed in the upper flange of the coil skeleton, and the magnetic tube is fixed in the lower end of the cylindrical body of the coil skeleton.

10. A coil skeleton assembly, comprising:
a coil skeleton around which a coil of a contactor is wound;
a magnetic tube fixed in the coil skeleton; and
a terminal module including a plurality of signal terminals and a retaining body holding the signal terminals together, the coil skeleton is directly molded onto the magnetic tube and the terminal module through embedded injection molding, the coil skeleton, the magnetic tube, and the terminal module are formed into an integral piece.

11. The coil skeleton assembly according to claim 10, wherein the retaining body is directly molded onto the signal terminals through embedded injection molding, so that the retaining body and the signal terminals are formed into an integral piece.

12. The coil skeleton assembly according to claim 10, wherein a plurality of positioning posts are formed on the retaining body, and the positioning posts are distributed at intervals on the retaining body to achieve positioning between the retaining body and the coil skeleton.

13. The coil skeleton assembly according to claim 10, wherein the signal terminals include:
a pair of coil signal terminals electrically connected with a pair of ends of the coil of the contactor; and/or
a pair of auxiliary contact signal terminals electrically connected with a pair of auxiliary contacts of the contactor.

14. The coil skeleton assembly according to claim 10, wherein the signal terminals include:
a pair of coil signal terminals, a pair of first ends of the coil signal terminals are exposed from an outside of the coil skeleton and electrically connect with a pair of ends of the coil of the contactor; and
a pair of auxiliary contact signal terminals, a pair of first ends of the pair of auxiliary contact signal terminals are exposed from the outside of the coil skeleton, and electrically connect with a pair of auxiliary contacts of the contactor.

15. The coil skeleton assembly according to claim 14, wherein a pair of second ends of the pair of coil signal terminals and a pair of second ends of the pair of auxiliary contact signal terminals are arranged in a row for insertion into a signal connector to electrically contact a plurality of mating signal terminals in the signal connector.

16. The coil skeleton assembly according to claim 15, wherein the coil skeleton has a mating portion, a slot for inserting the signal connector is formed in the mating portion, the second ends of the pair of coil signal terminals and the second ends of the pair of auxiliary contact signal terminals extend into the slot of the mating portion.

17. The coil skeleton assembly according to claim 15, wherein each of the coil signal terminals has a flat main body located between the first end and the second end, the flat main body of the coil signal terminal is perpendicular to an axial direction of the coil skeleton and wrapped in the coil skeleton, and after the ends of the coil are wound and connected to the first ends of the coil signal terminals, the first ends of the coil signal terminals are bent 90 degrees relative to the flat main bodies of the coil signal terminals, and the second ends of the coil signal terminals are bent 90 degrees or not bent relative to the flat main bodies of the coil signal terminals.

18. The coil skeleton assembly of claim 15, wherein each of the auxiliary contact signal terminals has a flat main body located between the first end and the second end, the flat main body of the auxiliary contact signal terminal is perpendicular to an axial direction of the coil skeleton and wrapped in the coil skeleton, the first ends of the auxiliary contact signal terminals are bent 90 degrees relative to the main bodies of the auxiliary contact signal terminals, and the second ends of the auxiliary contact signal terminals are bent 90 degrees or not bent relative to the flat main bodies of the auxiliary contact signal terminals.

19. The coil skeleton assembly according to claim 10, wherein the coil skeleton includes:
a cylindrical body having an upper end and a lower end opposite the upper end in an axial direction;
an upper flange formed on the upper end of the cylindrical body; and
a lower flange formed on the lower end of the cylindrical body, the coil is wound around the cylindrical body, the upper flange rests against an upper end of the coil and the lower flange rests against a lower end of the coil.

20. A method for manufacturing a coil skeleton, comprising:
providing a plurality of signal terminals and a magnetic tube; and
directly forming a coil skeleton by embedding injection molding on the signal terminals and the magnetic tube, the coil skeleton, the signal terminals, and the magnetic tube become an integral piece.
